(19) United States
(12) Patent Application Publication
(10) Pub. No.: US 2026/0208718 A1
(43) Pub. Date: Jul. 23, 2026

(54) METHOD AND DEVICE FOR ESTIMATING THE SPEED OF A VEHICLE

(71) Applicant: ITT Italia S.R.L., Lainate (Milano) (IT)

(72) Inventors: Pietro Macchi, Torino (IT); Stefano Serra, Saluzzo (Cuneo) (IT); Umberto Vignolo, Porte (Torino) (IT)

(21) Appl. No.: 19/144,424

(22) PCT Filed: Dec. 18, 2023
(86) PCT No.: PCT/EP2023/086326

§ 371 Date: Jun. 27, 2025

(30) Foreign Application Priority Data
Dec. 30, 2022 (IT) 102022000027363

(51) Int. Cl. B60T 17/22; F16D 66/00; F16D 66/02; G01P 3/02

(52) U.S. Cl. CPC B60T 17/22; F16D 66/00; G01P 3/02; B60T 2210/32; B60T 2250/04; F16D 2066/001; F16D 2066/003; F16D 2066/005; F16D 2066/006; F16D 66/02

(57) ABSTRACT

The method for estimating the speed of a wheeled vehicle provided with at least one brake comprising at least one braking element and a braked element, in which the braking element includes at least one force sensor, comprises the steps of: acquisition of a force signal (F, F′) generated by the at least one force sensor; analysis of the force signal (F, F′) in the time or frequency domain and calculation of at least one parameter of the force signal (F, F′); and calculation of a vehicle speed estimate (vₑₛₜ) in which the calculated value of the parameter is inputted into an estimate algorithm (Ap) for estimating the speed of the vehicle.

The following invention relates to a device and method for estimating the speed of a wheeled vehicle.

### SUMMARY

As is well known, road vehicles are generally equipped with sensors to detect a variety of parameters relating to their state, including their speed.

Among the most widely used speed sensors, the tachometer or phonic wheel is capable of detecting the angular speed of the vehicle wheel, which can then, once the geometry and in particular the radius of the vehicle wheel is known, be converted into a linear speed of vehicle progress.

The task of the present invention is to provide an additional methodology for real-time estimation of a vehicle's speed that can be implemented in addition to or instead of the existing one.

Within this technical task, one purpose of the present invention is to provide real-time estimation of a vehicle's speed by enhancing the functionality of a technology already installed in the vehicle.

Last but not least, the aim of the invention is to devise a device and a method that allows an estimate of the speed of a vehicle by means compatible with on-board installations and applications.

Last but not least, the aim of the invention is to devise a device and method for estimating the speed of a vehicle by means compatible with on-board installations and applications connected to remotely located recording and processing media.

This task as well as these and other purposes are achieved by a method for estimating the speed of a wheeled vehicle provided with at least one brake comprising at least one braking element and a braked element, in which the braking element includes at least one force sensor, characterized in that it comprises the steps of:
acquisition of a force signal generated by said at least one force sensor;
analysis of said force signal in the time or frequency domain and calculation of at least one parameter of said force signal; and
calculation of a vehicle speed estimate in which the calculated value of said parameter is inputted into an estimate algorithm for estimating the speed of the vehicle.

In a mode of embodiment of the invention the brake has an activated status, a deactivated status and a transitory status between the activated and deactivated status and vice versa, the calculation of the speed estimate being enabled or validated only when said brake is not in said transitory status.

In a preferred embodiment of the invention in said analysis in the time domain said parameter of said force signal includes the time distance between peaks of said force signal and in said analysis in the frequency domain said parameter of said force signal includes the first harmonic or fundamental frequency of the frequency spectrum of said force signal.

In a preferred embodiment of the invention said speed estimate algorithm provides an analytical function that links with a relation of inverse proportionality said parameter of said force signal to said estimate in said analysis in the time domain, and with a relation of direct proportionality said parameter of said force signal to said estimate in said analysis in the frequency domain.

The present invention also discloses a device for estimating the speed of a vehicle provided with at least one brake comprising a braked element, and at least one braking element provided with at least one force sensor;
characterized in that it comprises:
means for monitoring the activated/deactivated status of the brake; and
an electronic controller of the brake connected to said at least one force sensor;
wherein said electronic controller f the brake has at least one sliding memory buffer and a calculation algorithm of a vehicle speed estimate and is configured to perform the following operations:
acquisition on the sliding memory buffer of a force signal generated by said at least one force sensor during an activated or deactivated status of the brake;
analysis of said force signal in the time or frequency domain and calculation of at least one parameter of said force signal; and
calculation of said vehicle speed estimate in which the calculated value of said parameter is inputted into said speed estimate algorithm.

The invention stems from the intuition that useful information for estimating vehicle speed can in principle be obtained by analysing the signal generated off-braking or during braking by a sensorised brake with at least one force sensor.

This is provided that the sensor brake has micro surface and/or geometric irregularities, which are, however, quite common in both new and commercial brakes.

For speed estimation, it is necessary that, outside the braking, there is residual torque on the braked element with the vehicle in motion and, inside the braking, there is contact between the braking element and the braked element with the vehicle in motion.

### BRIEF DESCRIPTION OF THE DRAWINGS

Various forms of implementation are depicted in the attached drawings for illustrative purposes and should in no way be construed as limiting the scope of this illustration.

Various characteristics of different disclosed forms of realisation can be combined to form additional forms of realisation, which are part of this illustration.

FIG. 1 shows schematically a corner of a vehicle properly configured to estimate vehicle speed;

FIG. 2 shows an architecture of a device for estimating vehicle speed, in accordance with a first embodiment of the invention;

FIG. 3 shows an architecture of a device for estimating vehicle speed, in accordance with a second embodiment of the invention;

FIG. 4 shows an architecture of a device for estimating vehicle speed, in accordance with a third embodiment of the invention;

FIG. 5 shows the time course of the force signal in the field outside the braking, in the field inside the braking and in the transition field between the field outside the braking and the field inside the braking;

FIG. 6 shows the calculation model for speed estimation by force signal analysis in the time domain;

FIG. 7 shows the calculation model for speed estimation using force signal analysis in the frequency domain;

FIG. 8 shows the congruence of the estimation obtained by a method in accordance with the present invention compared to a direct measurement of speed obtained with a speed sensor;

FIG. 9 shows a plan view of a sensorised brake pad with which the method of the invention can be implemented.

### DETAILED DESCRIPTION OF SOME FORMS OF REALISATION

In the following detailed description, reference is made to the attached drawings, which form a part of this description.

In drawings, similar reference numbers typically identify similar components, unless the context dictates otherwise.

The preferred forms of execution described in the detailed description and drawings are not intended to be limiting.

Typically, components relating to only one corner of the vehicle are illustrated.

Other forms of realisation can be used and other modifications can be made without departing from the spirit or scope of the topic presented here.

The aspects of this illustration, as described in a general manner herein and illustrated in the figures, can be arranged, substituted, combined, separated and designed in a wide variety of different configurations, all of which are explicitly contemplated and present in this illustration.

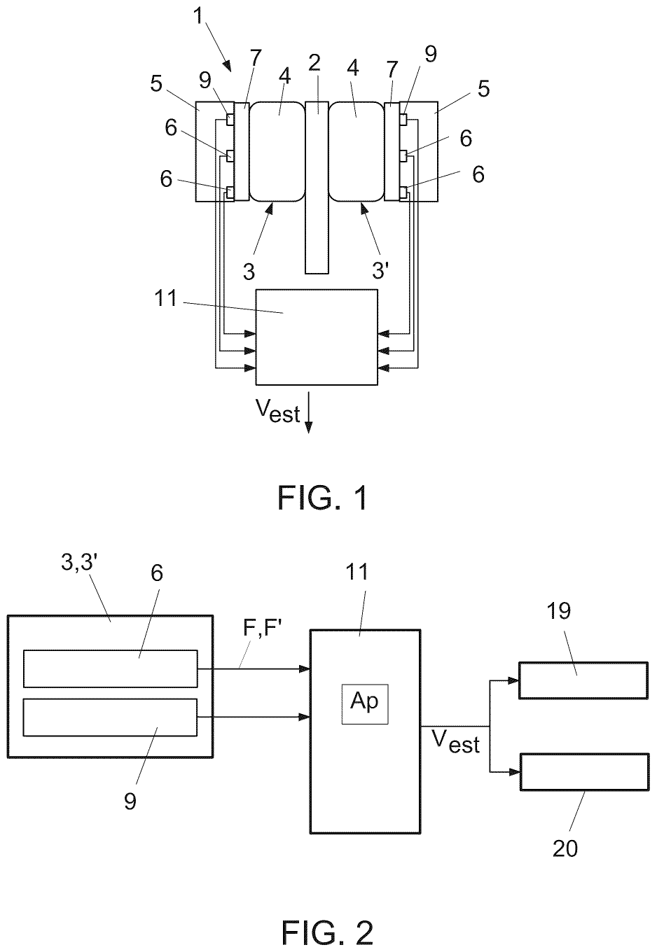

According to the present invention, as illustrated schematically in FIG. 1, the corner of the vehicle is duly equipped with a brake 1 comprising a braked element 2 and at least one braking element 3, 3′, particularly two braking elements 3, 3′.

Each braking element 3, 3′ includes a wearable block of friction material 4 and a rear support plate 5, typically metal, between which is interposed at least one force sensor 6, e.g. of the piezoceramic type.

A cushioning layer 7 can be provided between the rear support plate 5 and the friction material block 4.

Brake 1 can be of the drum or pad type.

In the case illustrated below, we will refer to a pad brake 1 in which the braked element 2 is a disc and the two braking elements 3, 3′ are operational on opposite sides of the disc and consist of a right-hand and a left-hand pad of which at least one is sensed with at least one force sensor.

In the case of a drum brake, there will be a drum as the braked element and two brake shoes as the braking elements, at least one of which will be sensorised with at least one force sensor.

Preferably the braking element 3, 3′ includes more than one force sensor 6, in particular at least one normal force sensor and/or at least one shear force sensor.

The force sensors 6 are connected to an electrically isolated circuit 8 located on the side of the rear support plate 5 facing the friction material block 4.

The braking element 3, 3′ advantageously can also include at least one temperature sensor 9 connected to the electrical circuit 8.

Temperature sensor 9 is configured and positioned to preferably acquire the temperature of the rear support plate 5.

Electrical circuit 8 has an electrical interface connector 10 for the transmission of electrical signals generated by sensors 6, 9 to an electronic control unit 11 of brake 1, and electrical tracks 10′ connecting sensors 6, 9 to electrical connector 10.

As we shall see, the electronic control unit 11 of brake 1 can interact with the electronic control unit 12 with which the vehicle is normally equipped.

Furthermore, as we shall see, the electronic control unit 11 of brake 1 can interact with other sensors installed in the vehicle directly or via the vehicle's electronic control unit 12.

Said sensors may include, for example, a vehicle brake on/off status sensor 13, a vehicle speed sensor 14, a vehicle acceleration sensor 15, a temperature sensor 16 of the environment outside the vehicle, a temperature sensor 17 of the braked element 2, and a vehicle wheel speed and/or angular acceleration sensor 18.

The method for estimating vehicle speed comprises the following steps.

The electronic control unit 11 of brake 1 monitors the activated/deactivated status of brake 1 via special monitoring means.

This monitoring can be carried out by the electronic control unit 11 of brake 1 via a direct connection to brake activation/deactivation status sensor 13 or via a connection to the vehicle's electronic control unit 12, which in turn is connected to brake activation/deactivation status sensor 13.

As an alternative to checking the brake 1 activation/deactivation status via sensor interrogation 13, it is also possible to use suitable algorithms for estimating the brake 1 activation/deactivation status as a means of monitoring.

The electronic control unit 11 of brake 1 temporally acquires the force signal F, F′ generated during an activated or deactivated status of brake 1 from the force sensors 6 in each sensorised braking element 3, 3′ of brake 1.

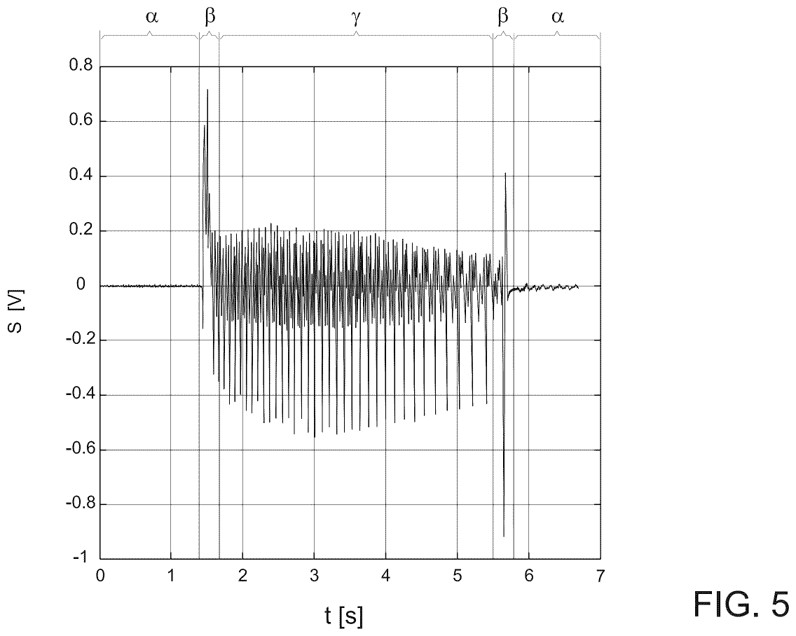

FIG. 5 shows a graph of the typical time course of a raw signal S generated by a force 6 sensor: time fields α are associated with a deactivated status of brake 1, time field γ is associated with a activated status of brake 1, and time fields β are associated with transitory statuses between deactivated and activated statuses and vice versa of brake 1.

The force signal F, F′ is defined by a part of the signal S in the time field γ or in the time field α. Electronic control unit 11 of brake 1 analyses the force signal F, F′ in the time or frequency domain and calculates at least one parameter of the force signal F, F′.

The electronic control unit 11 finally calculates an estimate vₑₛₜ of vehicle speed and to do this it gives the calculated value of at least one parameter as input to a speed estimation algorithm Ap.

The nature of the parameter used depends on the type of analysis performed on the force signal F, F′, whether in the time domain or in the frequency domain.

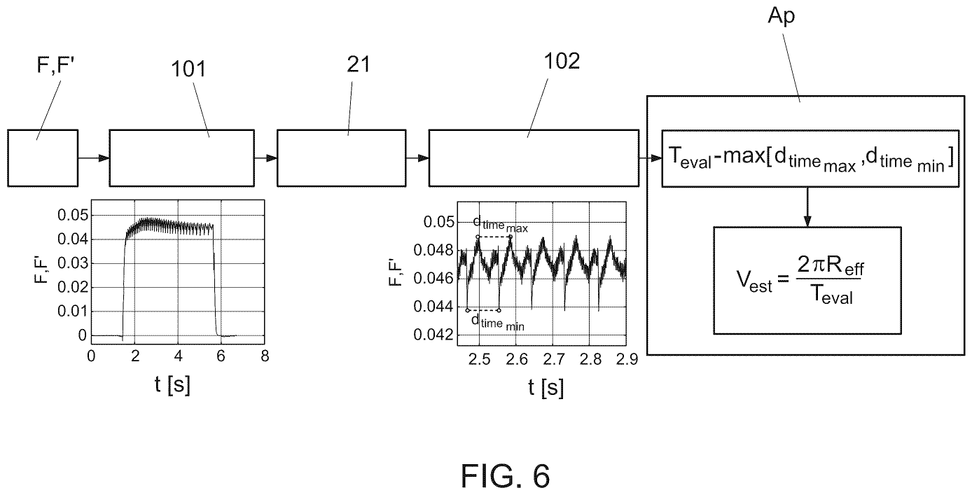

FIG. 6 shows an example of an analysis performed in the time domain.

The raw signal of force F, F′ is subjected to a pre-processing stage 101, i.e. it is subjected to a pseudo-integration over time, in order to mitigate data distortion due to the impulsive nature of the data, without, however, dispersing its information content.

The time course of the force signal F, F′ thus pre-processed is illustrated by the graph in FIG. 6 below the box schematising the pre-processing stage 101.

At this point, the pre-processed force signal F, F′ is acquired by a sliding memory buffer 21 with which the electronic control unit 11 is equipped.

The width of the sliding memory buffer 21 is preferably between 0.2 s and 1 s.

The force signal F, F′ acquired is analysed using a known real-time peak detection algorithm 102.

The calculated parameter is the time distance between peaks of the acquired force signal F, F′.

More precisely, the temporal distance between consecutive homologous peaks, i.e. between peaks of essentially equal intensity, is calculated.

Both the temporal distance dₜᵢₘₑₘᵢₙ between consecutive homologous peaks of low intensity and the temporal distance dₜᵢₘₑₘₐₓ between consecutive homologous peaks of high intensity are then calculated, as shown in the graph in FIG. 6 below the box schematising Algorithm 102.

The two parameters thus calculated are given as input to the speed estimation algorithm Ap.

The speed estimation algorithm Ap compares the values of dₜᵢₘₑₘᵢₙ and dₜᵢₘₑₘₐₓ, and selects the larger value Tₑᵥₐₗ of the two values.

At this point, the algorithm is able to calculate the estimate vₑₛₜ with the following formula:

$${v}_{est} = 2 π {R}_{eff} / {T}_{eval}$$

where R_{eff} is the effective radius of the vehicle wheel.

The frequency of calculation of the estimation vₑₛₜ of vehicle speed can be set equal to the inverse of the width of the sliding memory buffer 21.

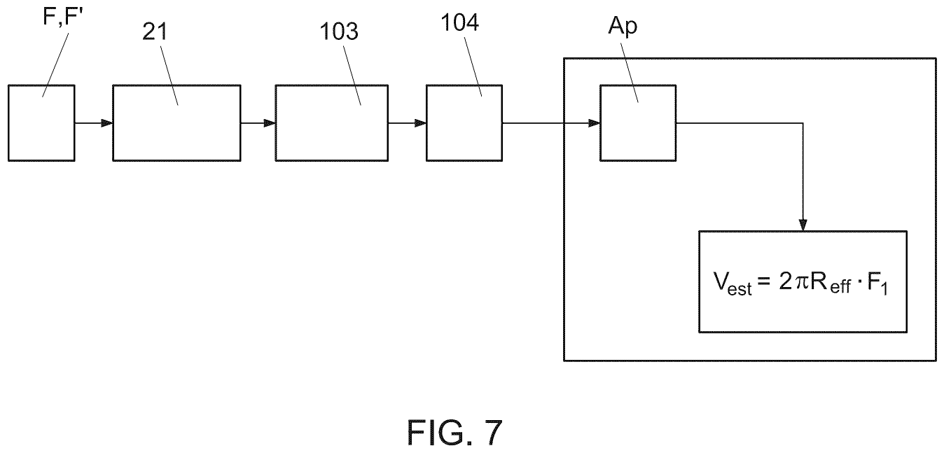

FIG. 7 shows an example of an analysis performed in the frequency domain.

The raw force signal F, F′, possibly pre-processed as mentioned above, is acquired by the sliding memory buffer 21 with which the electronic control unit 11 is equipped.

The width of the sliding memory buffer 21 is preferably between 0.2 s and 1 s.

The force signal F, F′ acquired is windowed by a windowing stage 103.

At windowing stage 103, for example, a Gaussian window function or a Hamming or other type of window function can be used.

In analysis stage 104, the frequency spectrum of the windowed and made periodic force signal F, F′ is calculated.

This can be done by applying a known integral transform, e.g. but not necessarily the Fast Fourier Transform (FTT), to the windowed and periodic force signal.

In analysis stage 104, the amplitudes and frequencies of the harmonics contained in the force signal transform are calculated, the frequency f₀ associated with the continuous component of the force signal transform is eliminated to eliminate the source of DC noise, and the frequency f₁ of the main harmonic of the force signal transform is identified using known peak detection techniques.

The algorithm Ap for calculating the estimate vₑₛₜ of vehicle speed uses this frequency f₁ of the main harmonic as the parameter for calculating vₑₛₜ.

The algorithm Ap is able to calculate the estimate vₑₛₜ with the following formula:

$${v}_{est} = 2 π {f}_{1} {R}_{eff}$$

where R_{eff} is the effective radius of the vehicle wheel.

With reference to all applications above, in the case where the braking element 3, 3′ has several force sensors 6, the electronic control unit 11 of the brake 1 obtains the force signal F, F′ as an average of the signals from the force sensors 6.

The method for estimating vehicle speed can be further refined.

To do this, the electronic control unit 11 of brake 1 inputs the calculated value of the parameter together with acquired measurement values and/or acquired estimates of physical parameters representative of the state of brake 1 and/or the vehicle to the calculation algorithm Ap.

The values and/or estimates of at least one physical parameter are preferably acquired during the acquisition of the force signal F, F′.

Where applicable, the values of acquired measurements and/or acquired estimates of physical parameters representative of the status of the brake and/or vehicle are also used for the calculation of the force signal parameter F, F′.

With the basic architecture of the vehicle speed estimation device illustrated in FIG. 2, the electronic control unit 11 of the brake 1 for all sensorised braking elements 3, 3′ also equipped with a temperature sensor 9 also acquires the temperature measured by the temperature sensor 9 and uses the temperature signal T, T′ detected by the temperature sensor 9 and the force signals detected by the force sensors 6 to feed the calculation algorithm Ap.

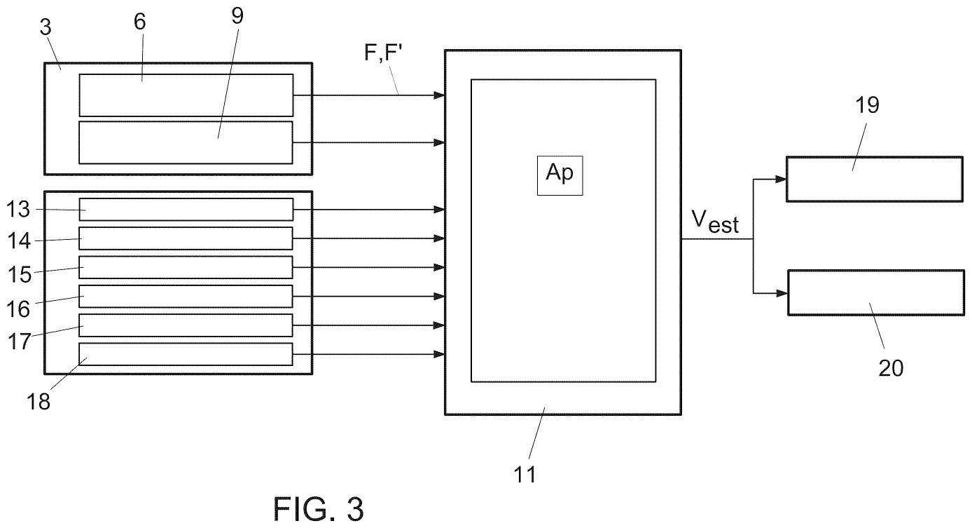

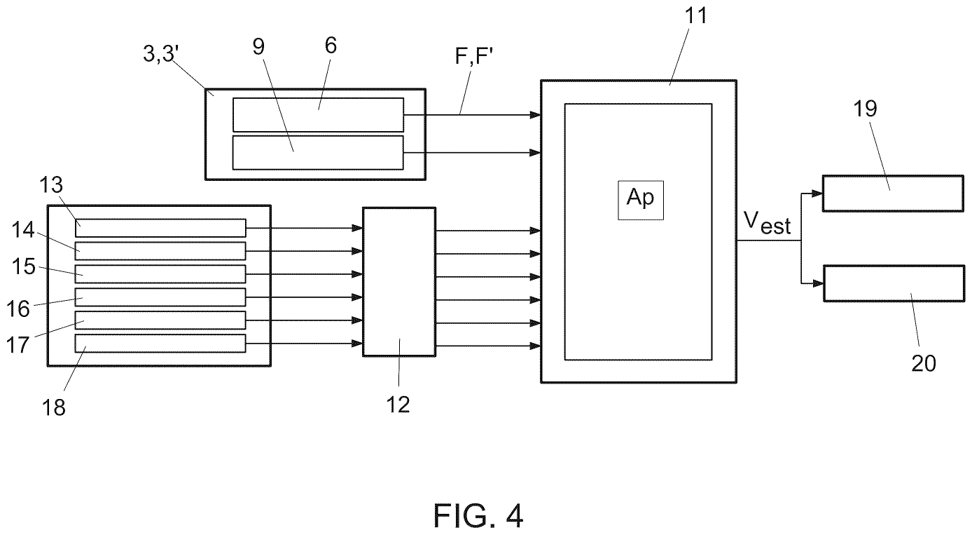

With the architecture of the vehicle speed estimation device illustrated in FIGS. 3 and 4, the electronic control unit 11 of the brake 1 for all sensorised braking elements 3, 3′ also equipped with a temperature sensor 9 acquires the temperature measured by the temperature sensor 9 and uses the temperature signal T, T′ detected by the temperature sensor 9, the force signals detected by the force sensors 6, and the signals detected by one or more of the sensors 13, 14, 15, 16, 17, 18 to feed the calculation algorithm Ap.

If necessary, the wear degree estimated by a special algorithm or measured from material block 4 can also be used to feed the algorithm Ap.

Advantageously, according to the present invention, the speed of the vehicle can be estimated by a single supervisory and control electronic processing unit (ECU) or by individual electronic processing units (ECU) 11 dedicated to each corner of the vehicle.

Advantageously, according to the present invention, the speed of the vehicle can be estimated in real time.

All acquisition and processing algorithms are independent of the type of vehicle and/or brake pad and/or driving style, thanks to a self-assessment of the calibration of the signal threshold: advantageously, no tuning operations are therefore required for different applications.

According to the present invention, the speed of the vehicle is estimated using direct measurements of the forces recorded by the braking elements 3, 3′.

Vehicle speed estimation can be used for pure monitoring, e.g. for the vehicle information and entertainment system 19 but also in closed-loop feedback applications, e.g. applications 20 BBW (Brake By Wire) for electric brakes and EMB (Electro Magnetic Brake or Electro Mechanic Brake) for electromagnetic or electromechanical brakes.

If a braking element is equipped with both at least one shear force sensor and at least one normal force sensor, the estimation of the vehicle speed may require only the measurement of the shear force sensor signals, only the measurement of the normal force sensor signals or both.

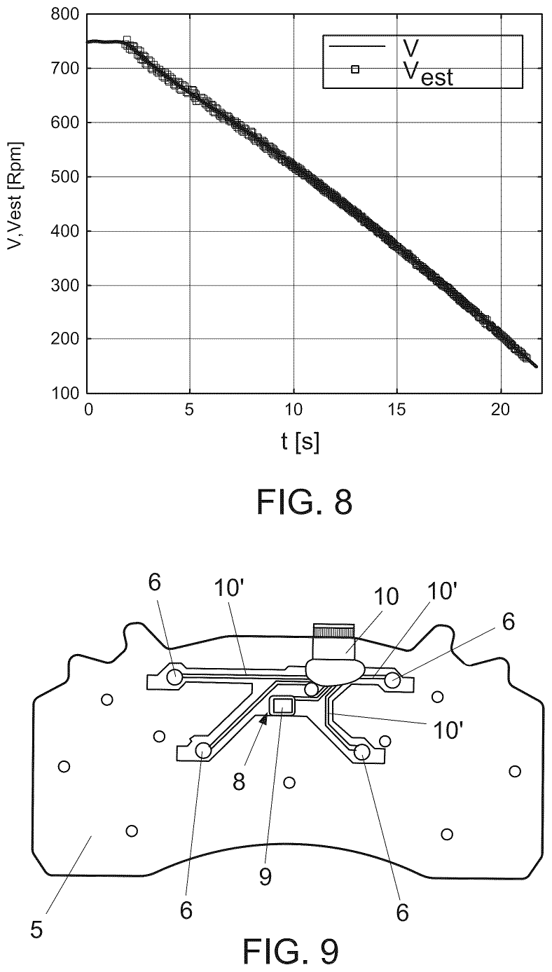

FIG. 8 shows a comparison graph between the estimated speed vₑₛₜ and the speed v actually measured, e.g. by the vehicle's speedometer. In abscissas are represented the time expressed in seconds, in ordinates are represented v and vₑₛₜ expressed in revolutions per minute (rpm).

Modifications and variations to the method and device for estimating vehicle speed beyond those described are of course possible.

The method of estimating vehicle speed conceived in this way is subject to numerous modifications and variations, all of which fall within the scope of the inventive concept as defined in the claims.

In addition, all details can be replaced with other technically equivalent elements.

In practice, the materials used, as well as the systems, can be of any type according to requirements and the state of the art.

1. A method for estimating a speed of a wheeled vehicle provided with at least one brake comprising at least one braking element and a braked element, in which the at least one braking element includes at least one force sensor, the method comprising:
acquisition of a force signal generated by the at least one force sensor;
analysis of the force signal in a time or frequency domain and calculation of at least one parameter of the force signal; and
calculation of a vehicle speed estimate in which the calculated value of the at least one parameter is inputted into an estimate algorithm for estimating the speed of the vehicle.

2. The method of claim 1, wherein the at least one brake can adopt an activated status, a deactivated status or a transitory status from the activated status to the deactivated status and vice versa, wherein monitoring the status of the at least one brake and enabling or validating the calculation of the vehicle speed estimate when the at least one brake is not in said transitory status.

3. The method of claim 1, wherein in the analysis in the time domain the parameter of the force signal includes a time distance between peaks of the force signal and in the analysis in the frequency domain the parameter of the force signal includes a first harmonic or fundamental frequency of a frequency spectrum of the force signal.

4. The method of claim 3, wherein the estimate algorithm provides an analytical function that links with a relation of inverse proportionality the at least one parameter of the force signal to the vehicle speed estimate in the analysis in the time domain, and with a relation of direct proportionality the at least one parameter of the force signal to the vehicle speed estimate in the analysis in the frequency domain.

5. The method of claim 4, wherein the at least one braking element includes a plurality of force sensors, and in that the force signal is acquired as an average of force signals generated by the plurality of force sensors.

6. The method of claim 1, wherein the force signal is acquired with a sliding buffer memory.

7. The method of claim 6, wherein the calculation frequency of the vehicle speed estimate is proportionate to an inverse of a size of the sliding memory buffer.

8. The method of claim 7, wherein the size of said sliding memory buffer is between 0.2 s and 1 s.

9. The method of claim 1, wherein the calculated parameter of the force signal is inputted into the estimate algorithm together with acquired measurement values and/or acquired estimates of physical parameters representing a status of the at least one brake and/or of the vehicle.

10. The method of claim 9, wherein for the calculation of the parameter of the force signal, the acquired measurement values and/or acquired estimates of physical parameters representing the status of the brake and/or of the vehicle are used.

11. The method of claim 9, wherein values and/or estimates of at least one physical parameter are acquired that include at least one of brake temperature, brake wear, speed/acceleration of the vehicle, angular speed/acceleration of the wheel of the vehicle, and/or ambient temperature.

12. The method of claim 9, wherein the values and/or estimates of at least one physical parameter are acquired during the acquisition of the force signal.

13. The method of claim 1, wherein the at least one brake comprises two braking elements each formed by a wearable block of friction material and a rear support plate between which the at least one force sensor is interposed.

14. A device for estimating a speed of a vehicle provided with at least one brake comprising a braked element, and at least one braking element provided with at least one force sensor; the device comprising:
means for monitoring an activated/deactivated status of the at least one brake; and
an electronic controller of the at least one brake connected to the at least one force sensor; wherein the electronic controller of the at least one brake has at least one sliding memory buffer and a calculation algorithm of a vehicle speed estimate and is configured to perform the following operations:
acquisition on the sliding memory buffer of a force signal generated by the at least one force sensor during an activated or deactivated status of the at least one brake;
analysis of the force signal in a time or frequency domain and calculation of at least one parameter of the force signal; and
calculation of the vehicle speed estimate in which the calculated value of the at least one parameter is inputted into the estimate algorithm.
